(19) United States
(12) Patent Application Publication
(10) Pub. No.: US 2008/0127832 A1
(43) Pub. Date: Jun. 5, 2008

(54) Transparent Foldable Dust Bag

(76) Inventor: YUEJIE ZHANG, FRANKFORT, IL (US)

Correspondence Address: YUEJIE ZHANG, 7541 W. LAKESIDE DR., FRANKFORT, IL, 60423-8667, US

(21) Appl. No.: 12/036,237

(22) Filed: Feb. 23, 2008

(51) Int. Cl. B01D 46/00

(52) U.S. Cl. 96/416; 55/361

(57) ABSTRACT

A transparent foldable dust bag is designed as an attachment for a vacuum cleaner and like. The transparent foldable dust bag has a foldable outer transparent wall portion and a foldable inner filter cone portion connected by the top connector and the bottom flange to form a hollow cavity for separating and collecting dirt and dust from air. Opened dust bag is deployed and stretched by the rigid top connector and bottom flange for keeping the shape of the dust bag in a designed position. See through the outer transparent wall of the dust bag allows to look filling level inside of the dust bag and to replace it properly without exposing collected dust and dirt.

### TECHNICAL FIELD AND INDUSTRIAL APPLICABILITY OF THE INVENTION

The present invention relates to an attachment for a vacuum cleaner and like, more particularly to a unique structural arrangement for seeing through a dust filter bag widely and better retaining a flexible transparent foldable dust bag in a designed working shape and position in a vacuum cleaner during separating dust from suck air.

### BACKGROUND OF THE INVENTION

Collection equipments for separating dust, dirt and similar material from air, such as vacuum cleaners, require the use of dust bags or containers for the material to be collected.

Theses conventional dust bags combine the functions of filtering and collecting. They can consist of paper, or any other filtration type material which are light and flexible. A filter bag has porosity sufficient for passing air and trap dust.

Typically these dust bags are provided with an intake opening through which the dust or dust-like particles is to be transported and collected within the bags. As the dust or dust-like material are accumulated into a bag and then a filled bag is disposed. A dust bag minimizes opportunities to expose and contact collected dust by hand directly. A filter material is opaque normally that prevent people from watching current inside filling situation of dust bag directly. As long as the accumulation of dust, some methods are necessary to measure when it is time to replace a filled bag. In all of known dust bag designs the replacing of filled dust bag are depended on pressure differences measurement.

The bag-less technology separates the functions of collecting and filtering. Normally a durable filter or a cyclone device is used to separate dust and air, and trap dust and dirt in a surrounding transparent container. These containers can be made from strength plastic, or any other strength lighter and transparent type container material. Dirt and dust are seen and then a filled transparent container will be picked out from a position in a vacuum cleaner and poured out into a garbage bin. These filters can consist of paper, or any other filtration type material which trap dust and form airflow path. The cyclone separating technology has advantage on collecting coarse particle and disadvantage on filtering fine particles. A conventional filter can be combined into a cyclone type vacuum cleaner for increasing the capacity of collecting fine particles. Durable filters or washable filters are to be replaced or cleaned in a designed long period in most of bag-less vacuum cleaner. Sooner or later there still are some opportunities to expose and touch dirty filters by hand.

These conventional filter dust bag receive dirt and dust air into the interior of the dust bag and trap dirt and dust in the inside of the filter bag and expel cleaned air outside of the filter dust bag. The force of air blow keeps the opening of the filter dust bag. An opposite air flow will suck and collapses the soft and flexible filter dust bag.

A need is identified for a way to retain the advantages of flexible filter dust bags and transparent bag-less containers; and to reduce the disadvantages affection of no transparent filter material and touching dirty on durable filters.

### SUMMARY OF THE INVENTION

It is an object of the present invention to watch dust collecting process visually and to replace a filled dust bag properly without exposing and touching dirt and dust. This object is solved by a transparent foldable dust bag by a reverse airflow path method and reinforced filter dust bag according to claim 1, 2, 3, 4, 5, 6.

According to the invention a transparent foldable dust bag for collecting dust-like material equipments, particularly for vacuum cleaners, with two opposing wall portion of an inner opaque air pervious material and an outer transparent impervious package material are joined together by a top connector and a bottom flange for forming a hollow cavity. Dirt air intake is opened in the top connector and air outlet is provided in the bottom flange. The top connector is coupled with the air discharge outlet of the vacuum cleaner. Dirty air is directed into the hollow cavity and then dirt is trapped in outside of the inner filter. Clean air can penetrate into interior of the inner filter and flow out from the outlet in the bottom flange which is attached to the vacuum cleaner.

This bag can be shipped and stored in compact, folded condition. When open the bag by turning over the top connector and bottom flange, the bag deploys a hollow cavity which works as a dust bag in the airflow path of the vacuum cleaner.

The top connector of the dust bag according to the invention can be made of lightly material selected from the group comprising paper, synthetic material, plastic material as known to someone in the art. It provides a top structure of the dust bag and an airflow path connection to the vacuum cleaner.

The inner filter cone portion of the dust bag according to the invention can be made of filtering materials selected from the group comprising paper, fiber, synthetic material as known to someone skilled in the art. It is in the center of the dust bag and form the inner structure portion of the dust bag. It provides an inner airflow path and prevents dust outside and flow cleaned air inside of the filter.

The outer transparent pocket portion of the dust bag according to the invention can be made of a package material selected from the group flexible transparent ethylene vinyl acetate, polyethylene, poly-nylon, plastic films as known to someone skilled in the art. It forms outer structure of the dust bag to trap and retain the dirt and dust picked up from the surface to be cleaned by the vacuum cleaner.

The reinforcement rings of the dust bag according to the invention can be made from a group of plastic material, vinyl, polyethylene as known to someone skilled in the art. They support the outer transparent pocket portion against suction force to keep the opening of the hollow cavity of the dust bag.

The bottom flange of the dust bag according to the invention can be made of light material selected from the group comprising paper board, vinyl acetate, plastic board as known to someone skilled in the art. It constructs an outlet of airflow path and support the inner filter cone and outer transparent pocket. It connects to the vacuum cleaner.

The dust bag comprises airtight part of the outer transparent pocket and permeable part of the inner filter cone. The suction force generated from the vacuum cleaner intends to attract inside of the flexible foldable outer transparent pocket approach to the inner filter cone and close the airflow path. For keeping the opening of the transparent foldable dust bag, the present invention comprise a rigid top connector, a rigid bottom flange, and reinforce rings. Opened top connector and bottom flange stretch the outer transparent pocket when the dust bag is installed on the vacuum cleaner.

Reinforce rings are attached to the side wall of the outer transparent pocket by glue or heat sealing. The inner filter cone is arranged in the center of the outer transparent pocket and they are sat on the support bottom flange. The outer transparent pocket is attached to the top connector and the bottom flange. These parts combine a foldable dust bag. An opening inlet receives dust air and dirt passing through the top connector and following into the hollow cavity between the outer transparent pocket and the inner filter cone, dust and dirt are collected in the hollow cavity and cleaned air flow into interior of the inner filter cone, and pass through the bottom flange into the vacuum cleaner. The combined functions of the reinforcement rings and stretching force from the top connector and the bottom flange keeps the dust bag in designed shape and position in the vacuum cleaner. Looking through the outer transparent pocket of the dust bag, a filling level of the dust bag is identified visually. The filled dust bag is taken from the vacuum cleaner by disassembling the top connector and pulling the bottom flange of the dust bag from the vacuum cleaner. Collected dust and dirt always be kept inside of the hollow cavity of the transparent foldable dust bag without exposing to air or touching by hand.

### IN THE DRAWINGS

Hereinafter are described preferred embodiments of the transparent foldable dust bag apparatus 10 according to the invention.

FIG. 1 is a perspective view of the transparent foldable dust bag 10 in folded, shipping and storage position.

FIG. 2 is a perspective view of the transparent foldable dust bag 10 as it is opened and stretched in the vacuum cleaner.

FIG. 3 is a cross-sectional view of the transparent foldable dust bag 10 taken in FIG. 2.

### REFERENCE NUMBERS

10 A transparent foldable dust bag
1 The top connector
2 The inner filter cone
3 Reinforce rings
4 The outer transparent pocket
5 The bottom flange

### DETAILED DESCRIPTION OF THE INVENTION

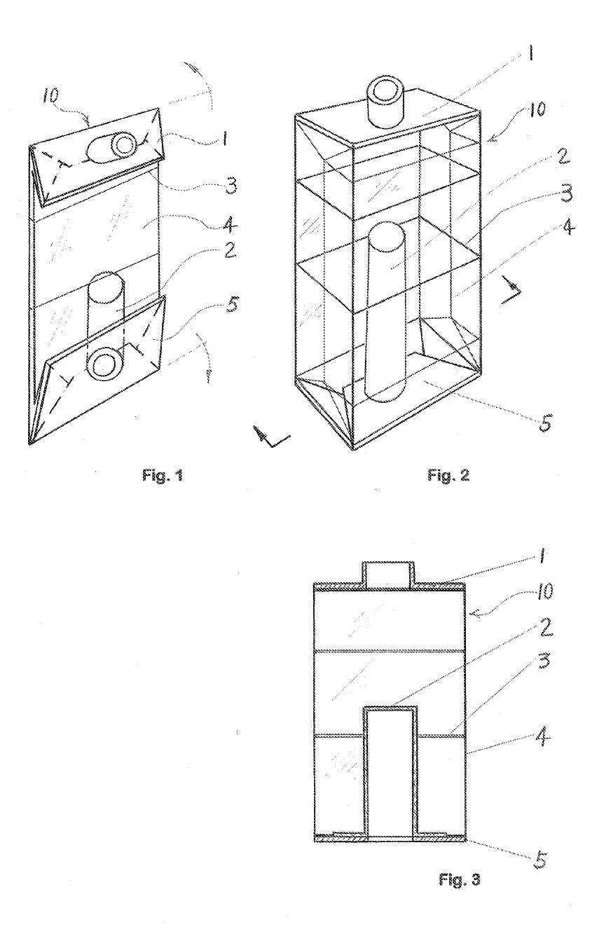

The present invention can be applied generally in a vacuum cleaner like; in the exemplary embodiment described hereinafter, the invention will be explained with the reference to an apparatus of a transparent foldable dust bag 10 illustrated in FIG. 1, FIG. 2, and FIG. 3.

A dust bag, embodying the principles of my invention, is shown generally at 10 will be mounted on a vacuum cleaner and like.

The transparent foldable dust bag 10 is illustrated in FIG. 1, FIG. 2, and FIG. 3. The dust bag 10 comprises a top connector 1, an inner filter cone 2, an outer transparent pocket 4, and reinforce rings 3, and bottom flange 5 shown in FIG. 1, FIG. 2, and FIG. 3.

The top connector 1, the inner filter cone 2, the outer transparent pocket 4, and the bottom flange 5 construct a hollow cavity that accept the dust air for separating and collecting dust and dirt as shown in FIG. 2 and FIG. 3.

The top connector 1 is made of light plastic material as know to someone skilled in the art. The top connector 1 is rigid as a frame to open and stretch the outer transparent pocket 4. The to connector 1 is the inlet of the dust bag 10. The top connector 1 is connected to the air discharge outlet of the vacuum cleaner for guiding dirt air into the hollow cavity of the dust bag 10.

The outer transparent pocket 4 is made of flexible transparent plastic package film material as know to someone skilled in the art. The outer transparent pocket 4 is transparent for watching inside of the dust bag. The outer transparent pocket 4 has a cylindrical shape. The suction force from the inner filter cone 2 intends to attract the flexible transparent pocket 4 to close the airflow path. The reinforce rings 3 are attached to side wall of the outer transparent pocket 4 to increase the strength of the stretched outer transparent pocket 4 and keep the opening of the dust bag 10. The reinforce rings 3 have a cycle shape and coincide within side wall of the outer transparent pocket 4. The reinforce rings 3 are made of plastic material or the same material as the outer transparent pocket 4. The combination of the reinforce rings 3, the rigid top connector 1, and rigid bottom flange 5 prevents the dust bag 10 to wave, collapse, and twist during dirt and dust picking up process of the vacuum cleaner.

The inner filter cone 2 is made of filter material. This filter material is one or combination of paper, synthetic material as known to someone skilled in the art. The inner filter cone 2 is air permeable to form an air outlet in the center of the dust bag 10. The inner filter cone 2 has a substantially cone shape that will benefit to be removed from the applied vacuum cleaner. The bottom of the inner filter cone 2 overlaps the bottom of the outer transparent pocket 4 on the surface of the bottom flange 5 by gluing or heat sealing together for strengthen. The inner filter cone 2 prevents dust and dirt outside of the filter cone 2 and permits filtered air flow into the interior of the filter cone 2.

The bottom flange 5 is made of plastic material. The bottom flange 5 is rigid as a frame to open and stretch the outer transparent pocket 4 as the function of the top connector 1. The bottom flange 5 is the construction base of the inner filter cone 2 and the outer transparent pocket 4. The bottom flange 5 provides an outlet of the dust bag 10 and airflow path to the vacuum cleaner.

As described above, dust and dirt air is sucked or discharged into the hollow cavity of the transparent foldable dust bag 10 and then dust and dirt are separated from drawn-in air and trapped in the hollow cavity where is inside of the outer transparent pocket 4 and outside of the inner filter cone 2. Clean air is drawn or emitted into the interior of the inner filter cone 2 of the dust bag 10 and discharge to the outlet of the vacuum cleaner. By seeing through the outer transparent pocket 4, a filling status is identified visually. The filled apparatus of a transparent foldable dust bag 10 is moved out from a vacuum cleaner. By detaching the top connector 1 and pulling out the bottom flange 5 from the vacuum cleaner, the transparent foldable dust bag 10 can be taken off from the location on the vacuum cleaner. Throwing the packed fulfilled transparent foldable dust bag 10 into a garbage bin, no collected dust and dirt are exposed to surrounded environment during the process of replacing the transparent foldable dust bag 10. A transparent foldable dust bag 10 is a disposable product.

What is claimed is:

1. A transparent foldable dust bag which filters out dust and dirt from drawn-in air in a vacuum cleaner and like, comprising:
A top connector, an inner filter cone, an outer transparent pocket, reinforce rings, and a bottom flange for separating and collecting the dust and dirt from the draw-in air; it trap dirt and dust outside of the inner filter cone and cleaned air flow into the interior of the inner filter cone.

2. The transparent foldable dust bag as claimed in claim 1, wherein: said the dust bag is compact, folded in shipping and storage position.

3. The transparent foldable dust bag as described in claim 1, wherein: said opened dust bag has a hollow cavity.

4. The transparent foldable dust bag as described in claim 1 wherein the top connector and the bottom flange open and stretch the dust bag in the assigned position of the vacuum cleaner.

5. The transparent foldable dust bag as described in claim 1 wherein exterior wall of the outer transparent pocket permits watching the dirt filling process for replacing the dust bag.

6. The transparent foldable dust bag as claimed in claim 1, wherein the reinforce rings coincide and strength the side wall of the outer transparent pocket.
